(19) United States
(12) Patent Application Publication
(10) Pub. No.: US 2025/0372899 A1
(43) Pub. Date: Dec. 4, 2025

(54) TERMINAL BLOCK

(71) Applicant: Yazaki Corporation, Tokyo (JP)

(72) Inventors: Yasuhiro TANAKA, Shizuoka (JP); Yasuhiro OTSUTA, Shizuoka (JP); Masatoshi YAMADA, Shizuoka (JP); Shogo FURUI, Shizuoka (JP); Masato AKINO, Shizuoka (JP)

(73) Assignee: Yazaki Corporation, Tokyo (JP)

(21) Appl. No.: 19/185,562

(22) Filed: Apr. 22, 2025

(30) Foreign Application Priority Data
May 28, 2024 (JP) 2024-086084

(51) Int. Cl. H01R 9/24

(52) U.S. Cl. CPC H01R 9/24

(57) ABSTRACT

A terminal block includes a housing that holds a terminal, at least two fastener members that fasten the housing to an attachment target object, a first water stop member that is provided in such a manner as to surround the fastener members, and stops water between the housing and the attachment target object, and a second water stop member that is formed into an annular shape in such a manner as to surround the terminal, and stops water between the housing and the attachment target object, in which the fastener members are provided at positions sandwiching the terminal, and the second water stop member is provided in such a manner as to surround the terminal, the fastener members, and the first water stop member.

### CROSS-REFERENCE TO RELATED APPLICATION(S)

The present application claims priority to and incorporates by reference the entire contents of Japanese Patent Application No. 2024-086084 filed in Japan on May 28, 2024.

### BACKGROUND OF THE INVENTION

### 1. Field of the Invention

The present invention relates to a terminal block.

### 2. Description of the Related Art

As described in Japanese Patent Application Laid-open No. 2023-102063, for example, a structure of holding a terminal in a housing (main body), providing two fastener units in such a manner as to sandwich the terminal, and performing water stop by between the housing and an attachment target object (attached portion) by an elastic member has been conventionally known as a terminal block. The terminal block is used by attaching the housing to the attachment target object by the two fastener units.

Such a terminal block has room for improvement in that the housing sometimes fails to be appropriately attached to the attachment target object. For example, in a case where the housing is attached to the attachment target object by the two fastener units in the above-described terminal block, the housing is attached to the attachment target object by initially performing fastening of one fastener unit and subsequently performing fastening of the other fastener unit. In this case, if one fastener unit is fastened earlier, a large clearance gap might be generated between the attachment target object and the housing at a position of the other fastener unit. That is, because an elastic member for water stop exists between one fastener unit and the other fastener unit, if the one fastener unit is fastened strongly, the housing at the other fastener unit gets away from the attachment target object with the elastic member serving as a fulcrum point. Thus, to attach the housing in parallel to the attachment target object, the other fastener unit needs to be fastened very strongly, and it becomes difficult to appropriately attach the housing to the attachment target object.

### SUMMARY OF THE INVENTION

In view of the foregoing, the present invention aims to provide a terminal block that can appropriately attach a housing to an attachment target object.

A terminal block according to one aspect of the present invention includes a housing that holds a terminal; at least two fastener members that fasten the housing to an attachment target object; a first water stop member that is provided in such a manner as to surround the fastener members, and stops water between the housing and the attachment target object; and a second water stop member that is formed into an annular shape in such a manner as to surround the terminal, and stops water between the housing and the attachment target object, wherein the fastener members are provided at positions sandwiching the terminal, and the second water stop member is provided in such a manner as to surround, the terminal, the fastener members, and the first water stop member.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view of a terminal block according to an embodiment;

FIG. 2 is an exploded perspective view of a terminal block according to an embodiment;

FIG. 3 is a cross-sectional view of a terminal block taken along III-III in FIG. 1;

FIG. 4 is an explanatory diagram of connection of a terminal block according to an embodiment;

FIG. 5 is an explanatory diagram of connection of a terminal block according to an embodiment, and illustrates a cross-section of a terminal block taken along V-V in FIG. 1; and

FIG. 6 is an explanatory diagram of a terminal block of a comparative example.

### DETAILED DESCRIPTION OF THE PREFERRED EMBODIMENTS

An embodiment according to the present invention will be described in detail below based on the drawings. In addition, the present invention is not limited by the embodiment. Further, components in the following embodiment include the ones that can be replaced by those skilled in the art, and are easy, or the ones that are substantially identical.

### EMBODIMENT

The present embodiment relates to a terminal block. In the following description, among a first direction, a second direction, and a third direction that intersect with each other, the first direction will be referred to as a “longer direction X”, the second direction will be referred to as a “width direction Y”, and the third direction will be referred to as an “attachment direction Z”. Here, the longer direction X, the width direction Y, and the attachment direction Z are orthogonal to each other. In addition, orthogonal here includes an approximately orthogonal state. The longer direction X corresponds to a direction in which a housing extends lengthwise. The attachment direction Z corresponds to a direction in which a housing is attached to an attachment target object. Further, each direction to be used in the following direction refers to a direction in a state in which components are assembled to each other, unless otherwise specified.

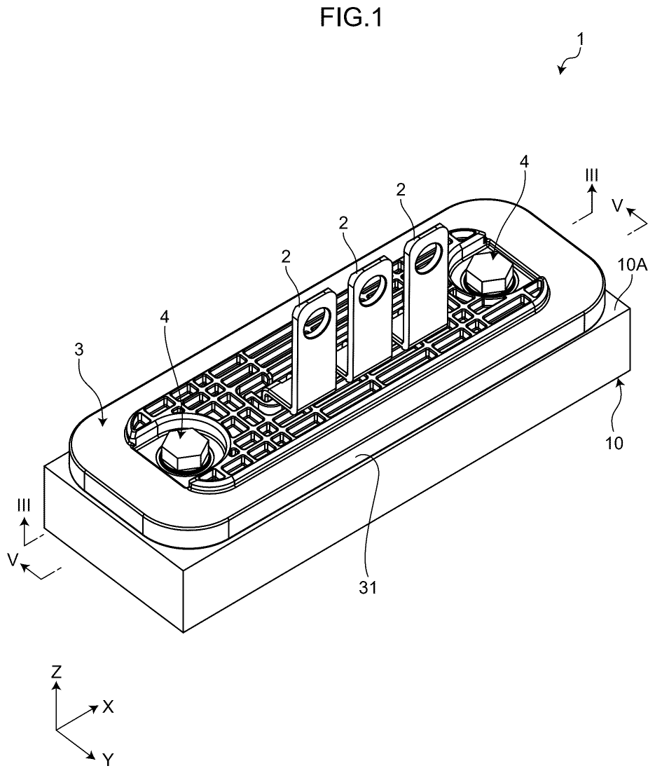

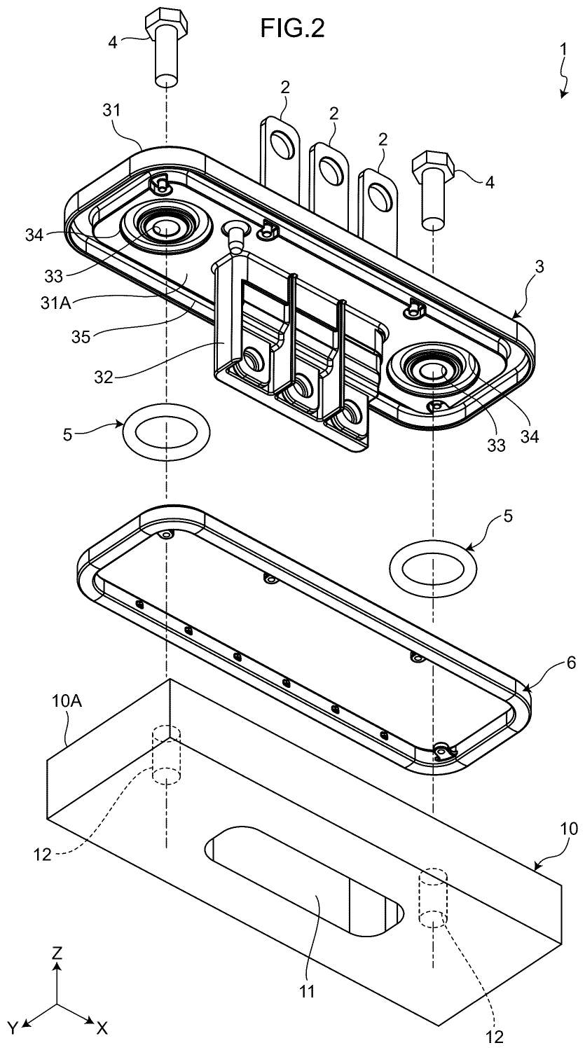

As illustrated in FIGS. 1 and 2, a terminal block 1 is a component holding a terminal 2, and is used with being attached to an attachment target object 10. The terminal block 1 is mounted on a vehicle, for example, and holds a plurality of terminals 2 with being arrayed along the longer direction X. The attachment target object 10 is a vehicle unit to be mounted on a vehicle or provided in a vehicle, and for example, is a component of a vehicle, or a component, a member, a device, or the like that is to be mounted on a vehicle. The terminal block 1 includes a housing 3, a fastener member 4, a first water stop member 5, and a second water stop member 6.

The housing 3 is a component that holds the terminal 2, and is to be fitted with the attachment target object 10, and has a configuration in which a protruding portion 32 protrudes from a main body portion 31, for example. The main body portion 31 has a plate shape, and is attached with being arranged in such a manner as to face an attachment surface 10A of the attachment target object 10. The main body portion 31 is a rectangular plate member with a length longer in the longer direction X as compared with that in the width direction Y, for example. The protruding portion 32 protrudes along the attachment direction Z from a surface facing the attachment target object 10 of the main body portion 31. The protruding portion 32 is inserted into a fit portion 11 formed in the attachment target object 10, when the terminal block 1 is attached to the attachment target object 10. The fit portion 11 is a hole formed in the attachment target object 10, and is formed by depressing the attachment surface 10A.

The terminal 2 is a member formed of a wire-conductive member, and for example, plate-like terminal hardware is used. The terminal 2 is provided toward the attachment direction Z, and penetrates through the main body portion 31 in the attachment direction Z. That is, the main body portion 31 holds the terminal 2 with penetrating toward the attachment direction Z. A plurality of terminals 2 is provided, and for example, three terminals 2 are provided side by side in the longer direction X. The terminal 2 is formed with being bent in a crank shape, for example. In other words, the terminal 2 is formed with bending from the attachment direction Z to the width direction Y, and bending from the width direction Y to the attachment direction Z. A portion of the terminal 2 that bends to the width direction Y is brought into contact with the surface of the main body portion 31, and a portion bending from the width direction Y to the attachment direction Z penetrates through the main body portion 31 to be arranged along the protruding portion 32.

The fastener member 4 is a member that fastens the housing 3 to the attachment target object 10, and for example, a bolt having a head portion and a screw portion is used. Two fastener members 4 are provided, and provided at positions sandwiching the terminal 2. For example, the fastener members 4 are arranged with being separated in the longer direction X, and attached to both sides in such a manner as to sandwich all three terminals 2 arrayed in the longer direction X. The fastener member 4 is inserted into an attachment hole 33 formed in the main body portion 31 of the housing 3, and inserted into an attachment hole 12 of the attachment target object 10 to be screwed. The attachment hole 33 is a hole penetrating through the main body portion 31 of the housing 3 toward the attachment direction Z. The attachment holes 33 are formed at positions sandwiching the terminal 2. The attachment holes 12 are provided in accordance with the formation positions of the attachment holes 33, and form screw grooves on their inner surfaces.

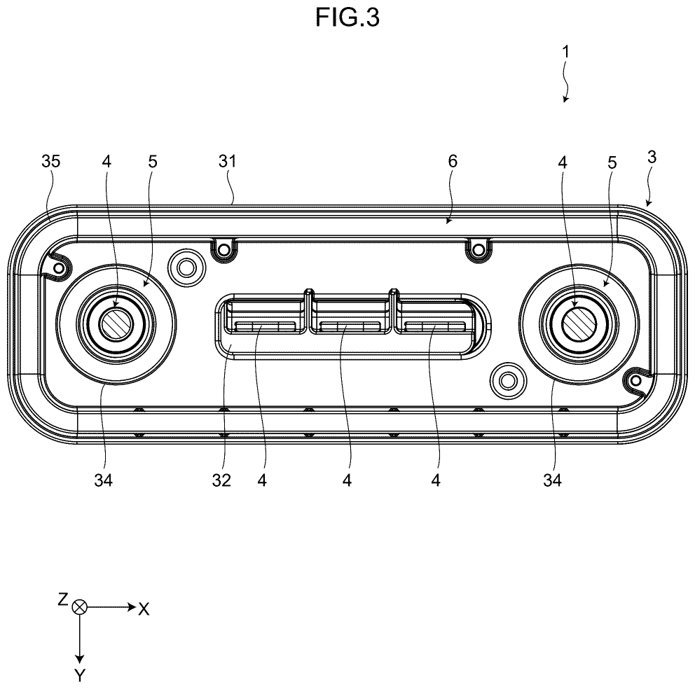

As illustrated in FIG. 3, the first water stop member 5 is a member that stops water between the housing 3 and the attachment target object 10, and is provided in such a manner as to surround the fastener member 4. For example, the first water stop member 5 is provided concentrically with the fastener member 4. The first water stop member 5 is formed of an annular elastic member, and performs water stop between an installation space of the fastener member 4 and the inside of the terminal block 1. The first water stop members 5 are respectively provided for the two fastener members 4. The first water stop member 5 can be attached to the housing 3. For example, the first water stop member 5 is attached with being fitted into a first groove portion 34 formed in the main body portion 31. The first groove portion 34 is a groove obtained by depressing a rear surface 31A of the main body portion 31 along the attachment direction Z, and is formed in accordance with the shape and the size of the first water stop member 5.

The second water stop member 6 is a member that performs water stop between the housing 3 and the attachment target object 10, and is provided in such a manner as to surround the terminal 2, the fastener member 4, and the first water stop member 5. The second water stop member 6 is formed of an annular elastic member, and performs water stop between the outside and inside of the terminal block 1. The second water stop member 6 is provided along an outer rim of the main body portion 31, for example. The second water stop member 6 can be attached to the housing 3. For example, the second water stop member 6 is attached with being fitted into a second groove portion 35 formed in the main body portion 31. The second groove portion 35 is a groove obtained by depressing a rear surface 31A of the main body portion 31 along the attachment direction Z, and is formed in such a manner as to surround the protruding portion 32, the attachment hole 33, and the first groove portion 34. In FIG. 2, the second water stop member 6 is formed into a rectangular frame shape, but in some cases, the second water stop member 6 is formed into a shape other than a rectangle.

Next, the connection of the terminal block 1 according to the present embodiment will be described.

The connection of the terminal block 1 according to the present embodiment to the attachment target object 10 is performed by sequentially executing, for example, fitting of the first water stop member 5 and the second water stop member 6 with the housing 3, fitting of the housing 3 with the attachment target object 10, and fastening of the fastener members 4.

As illustrated in FIG. 3, the fitting of the first water stop member 5 and the second water stop member 6 is a process of attaching the first water stop member 5 and the second water stop member 6 to the housing 3. That is, the first water stop member 5 is fitted into the first groove portion 34 of the housing 3, and the second water stop member 6 is fitted into the second groove portion 35. This causes a state in which the first water stop member 5 and the second water stop member 6 are attached to the housing 3.

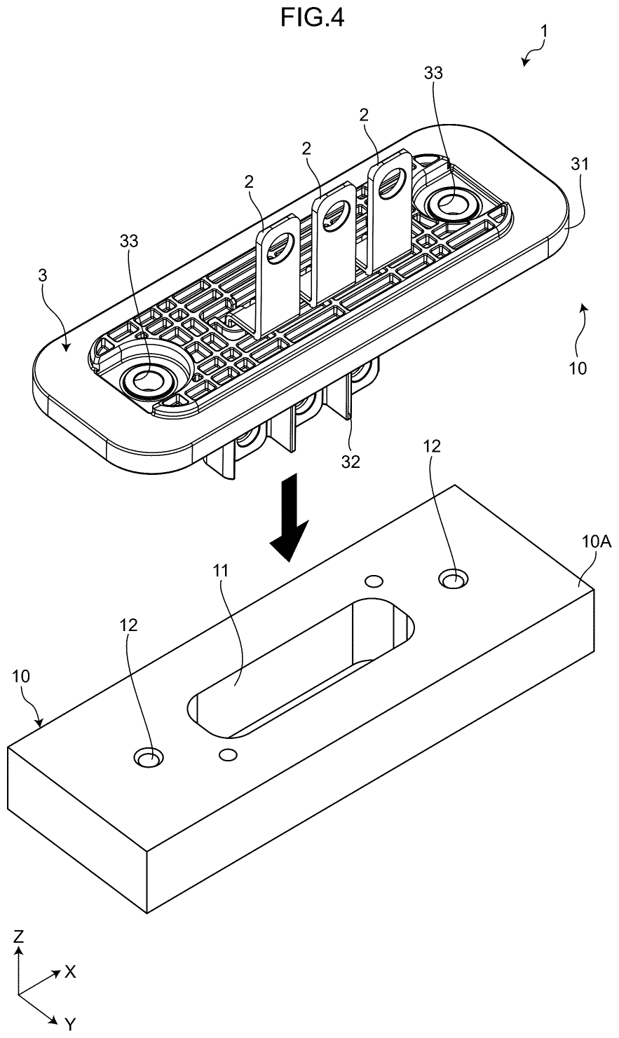

Then, as illustrated in FIG. 4, the fitting of the housing 3 to the attachment target object 10 is performed. That is, the housing 3 is arranged with the protruding portion 32 facing the attachment target object 10, and fitted with the attachment target object 10 in such a manner that the protruding portion 32 is inserted into the fit portion 11. At this time, the housing 3 is fitted in such a manner that the attachment hole 33 coincides with the position of the attachment hole 12 of the attachment target object 10.

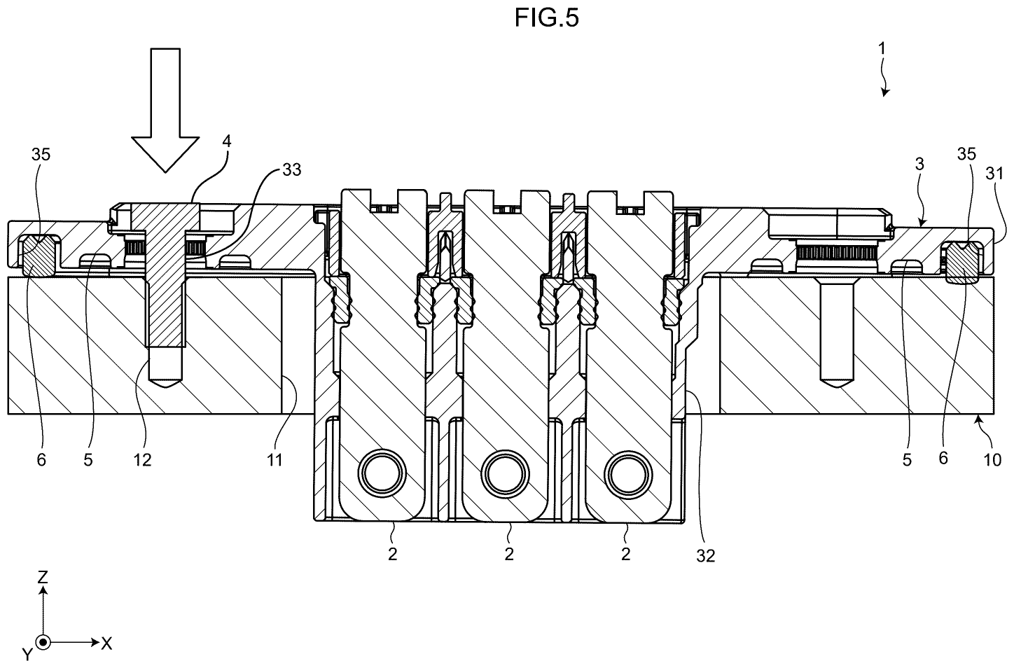

Then, as illustrated in FIG. 5, fastening of the fastener member 4 is performed. First of all, one fastener member 4 of the two fastener members 4 is inserted into the attachment hole 33, and inserted into the attachment hole 12 to be screwed. At this time, because the second water stop member 6 is provided in such a manner as to surround the fastener member 4, the second water stop member 6 is positioned outside the fastened fastener member 4. That is, the second water stop member 6 is not positioned between one fastened fastener member 4 and the other fastener member 4. Thus, even in a case where the fastener member 4 is strongly fastened, the housing 3 is unlikely to incline with respect to the attachment target object 10, and it is possible to appropriately attach the housing 3 to the attachment target object 10.

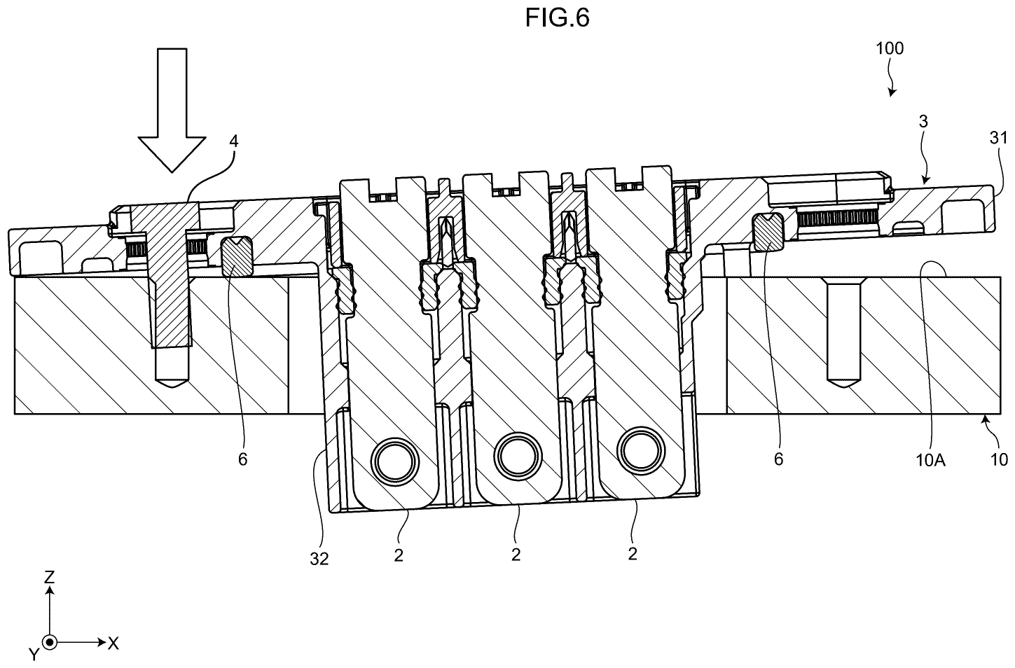

For example, as illustrated in FIG. 6, a terminal block 100 being a comparative example in which the second water stop member 6 is provided in such a manner as to surround the terminals 2, and is not provided in such a manner as to surround the fastener members 4 is illustrated. In the terminal block 100, by the fastening of the fastener member 4, the housing 3 might incline with respect to the attachment target object 10. That is, if one fastener member 4 is fastened, a large clearance gap might be generated between the attachment target object 10 and the housing 3 at a position of the other fastener member 4. In other words, because the second water stop member 6 exists between one fastener member 4 and the other fastener member 4, if the one fastener member 4 is fastened strongly, the housing 3 inclines with the second water stop member 6 serving as a fulcrum point, and the point of the other fastener member 4 gets away from the attachment target object 10. If the other fastener member 4 is fastened in this state, fastening torque of the fastener member 4 becomes large, fastening becomes difficult, and large stress is applied on the housing 3. Accordingly, in the terminal block 100, it is difficult to appropriately attach the housing 3 to the attachment target object 10 by the fastener member 4.

In contrast to this, by providing the terminal block 1 according to the present embodiment in such a manner that the second water stop member 6 surrounds the fastener member 4, the inclination of the housing 3 is suppressed, and the fastener member 4 can be attached with appropriate fastening torque. Accordingly, the terminal block 1 according to the present embodiment can appropriately attach the housing 3 to the attachment target object 10 by the fastener member 4.

If the fastening of all the fastener members 4 ends, the connection of the terminal block 1 according to the present embodiment to the attachment target object 10 is completed.

As described above, in the terminal block 1 according to the present embodiment, because the second water stop member 6 is provided in such a manner as to surround the terminal 2, the fastener member 4, and the first water stop member 5, when the housing 3 is attached to the attachment target object 10 by the fastener member 4, the housing 3 is prevented from inclining, and the fastener member 4 can be fastened with appropriate fastening torque. Accordingly, the terminal block 1 according to the present embodiment can appropriately attach the housing 3 to the attachment target object 10 by the fastener member 4.

In addition, the terminal block according to the present invention is not limited to the above-described embodiment, and various changes can be made within the scope set forth in the appended claims. The terminal block 1 according to the present embodiment may be formed by appropriately combining the components of the above-described embodiment and a modified example.

For example, the case where the above-described terminal block 1 according to an embodiment is mounted on a vehicle has been described, but may be used without being mounted on a vehicle.

According to a terminal block according to the present embodiment, it is possible to appropriately attach a housing to an attachment target object.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A terminal block comprising:
a housing that holds a terminal;
at least two fastener members that fasten the housing to an attachment target object;
a first water stop member that is provided in such a manner as to surround the fastener members, and stops water between the housing and the attachment target object; and
a second water stop member that is formed into an annular shape in such a manner as to surround the terminal, and stops water between the housing and the attachment target object, wherein
the fastener members are provided at positions sandwiching the terminal, and
the second water stop member is provided in such a manner as to surround, the terminal, the fastener members, and the first water stop member.
